(19) United States
(12) Patent Application Publication
(10) Pub. No.: US 2003/0228991 A1
(43) Pub. Date: Dec. 11, 2003

(54) Premix compositions suitable for the preparation of aqueous or semi-aqueous cleaning and degreasing formulations with low VOCs.

(76) Inventors: Andress Kirsty Johnson, Pleasantville, NY (US); Meiylin Fong Antezzo, Carmel, NY (US)

Correspondence Address: RALPH J. MANCINI, AKZO NOBEL INC., 7 LIVINGSTONE AVENUE, DOBBS FERRY, NY, 10522-3406, US

(21) Appl. No.: 10/159,367

(22) Filed: May 31, 2002

(51) Int. Cl. C11D 1/00; C11D 17/08

(52) U.S. Cl. 510/245; 510/421; 510/422; 510/470; 510/505; 510/506

(57) ABSTRACT

The present invention generally relates to premix compositions having low to zero VOCs according to EPA test methods which are thermally stable, free from HAP's, alkylphenol free, dispersible in cold water and can be formulated into acid or alkaline systems. The premix of the present invention formulates into a rapid degreasing formulation when combined with typical additives used in detergent formulations. The premix composition of the invention comprises at least one nonionic surfactant, at least one cationic surfactant, an effective amount a polyhydric alcohol, and optionally water. The formulations of the present invention can be used in the preparation of aqueous or semi-aqueous detergents formulations for household, institutional and industrial applications with low or zero VOCs.

### FIELD OF THE INVENTION

The present invention generally relates to cleaning and degreasing premix compositions having low to zero VOCs according to EPA test methods. The compositions according to the present invention are thermally stable, free from HAPs, alkylphenol free, dispersible in cold water and can be formulated into acid or alkaline systems. Additionally, they can be easily formulated into cleaning and degreasing formulations when combined with typical additives used in detergent formulations.

### BACKGROUND OF THE INVENTION

The process of cleaning and/or degreasing hard surfaces is multifaceted and generally involves emulsification, dispersion, saponification and denaturing of various soils. In order to address these needs formulators/compounders developed formulations based on ingredients including, but not limited to, solvents, nonionic surfactants, cationic surfactants, anionic surfactants, amphoteric surfactants, builder, chelating agents, hydrotropes, coupling agents polymers, and other minor additives perfume and dyes. Additionally, surfactant blends have been developed in order to provide several functions in a single product. However, due to environmental issues and increased customer pressure, formulators have had to review their current formulations for the presence of hazardous air pollutants (HAPs), volatile organic compound (VOC) content, alkylphenols and phosphates.

It is desirable therefore to provide an effective degreaser that does not contain the hazardous ingredients found in conventional cleaners. It is also an object of the invention to provide a cleaning and degreasing composition that has a low VOC profile.

### SUMMARY OF THE INVENTION

The present invention generally relates to premix compositions having low to zero VOCs according to EPA test methods which are thermally stable, free from HAPs, alkylphenol free, dispersible in cold water, and can be formulated into acid or alkaline systems. The premix of the present invention formulates into a rapid degreasing formulation when combined with typical additives used in detergent formulations. The premix composition of the invention comprises at least one nonionic surfactant, at least one cationic surfactant, an effective amount a polyhydric alcohol, and, optionally, water. The formulations of the present invention can be used in the preparation of aqueous or semi-aqueous detergents formulations for household, institutional, and industrial applications with low or zero VOCs.

### DETAILED DESCRIPTION OF THE FIGURES

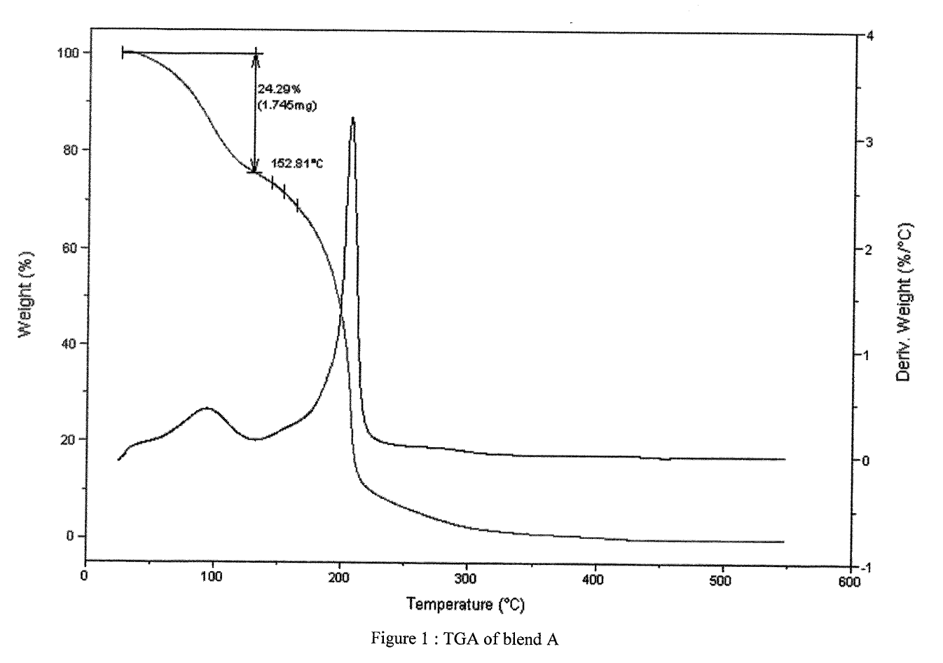

FIG. 1 is a Thermal Gravity Analysys (TGA) of blend A.

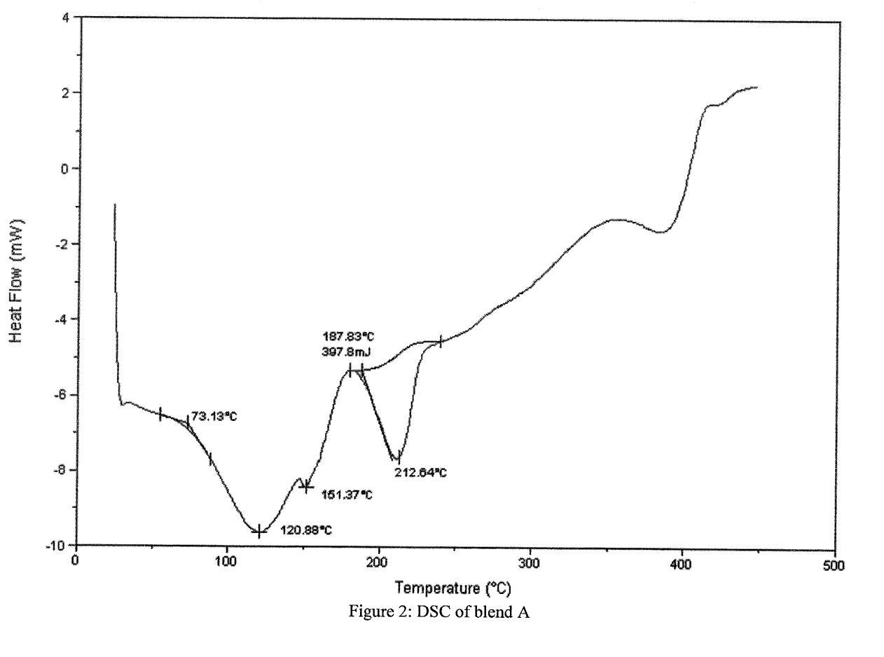

FIG. 2 is a Differential Scanning Colorimetry (DSC) of blend A

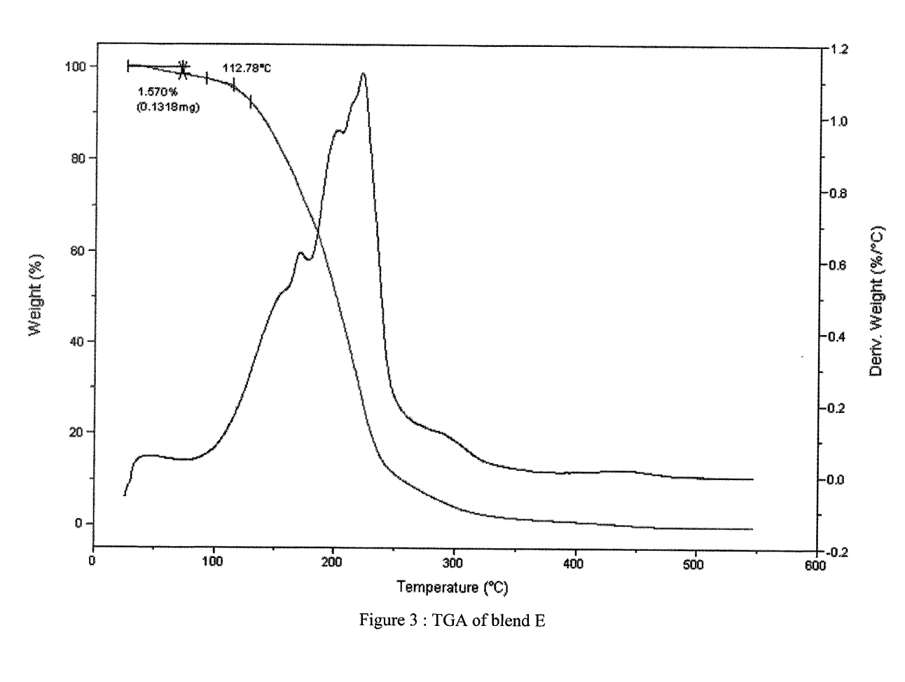

FIG. 3 is a TGA of blend E

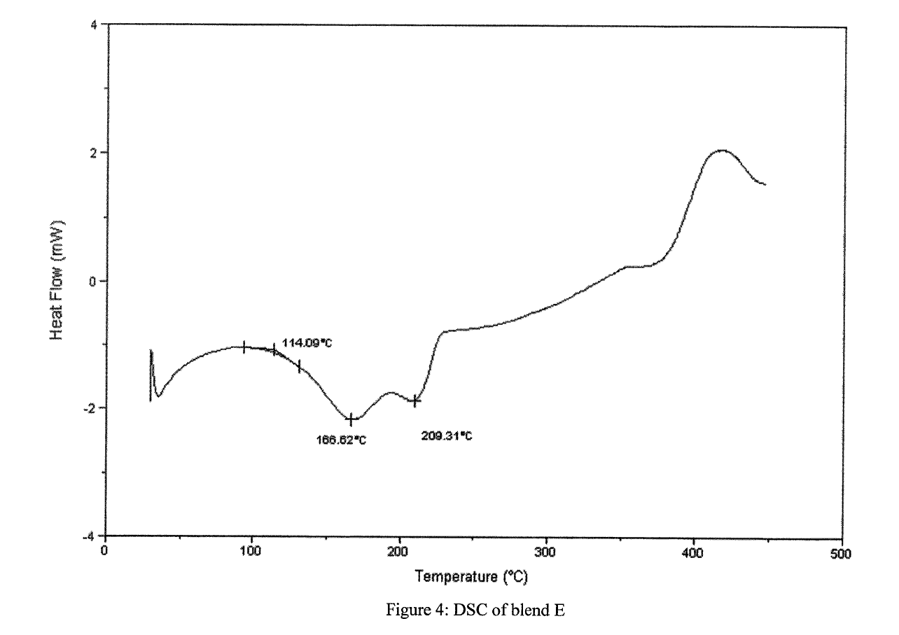

FIG. 4 is a DSC of blend E

### DETAILED DESCRIPTION OF THE INVENTION

In order to prepare a premix of a low free-alcohol nonionic surfactant and a hydrophilic quaternary ammonium compound, a solvent such as propylene glycol is typically added to avoid gelling issues when the formulation is added to cold water. However, VOC analysis according to EPA test method 24 found that such premixes have recordable VOCs. The present inventors evaluated alternative solvents and found that polyhydric alcohols such as glycerol provide similar dissolution properties and at the same time have zero VOCs using EPA test method 24. Further analysis found that the combination of glycerol and cationic surfactant results in superior thermal stability of the formulation at 120° C., a result that was not observed in formulations having propylene glycol as the solvent. A surprising boost in cleaning was also observed with the premix containing glycerol when compared to conventional cleaners and premix blends containing propylene glycol.

Accordingly, the present invention generally relates to premix compositions that are thermally stable, have low or zero VOCs according to EPA test methods, are HAP and alkylphenol free, are biodegradable, and are water dispersible. Additionally, the premixes of the present invention can be formulated into acid or alkaline systems, and can be formulated into an effective hard surface cleaners/degreasers when combined with typical additives used in detergent formulations.

The premix composition of the invention comprises at least one nonionic surfactant, at least one cationic surfactant, an effective amount a polyhydric alcohol, and optionally water. The present invention can be used in the preparation of aqueous or semi-aqueous detergent cleaning formulations for household, institutional, and industrial applications with lower or zero VOCs. This premix composition shows several improvements over conventional premix blends and cleaning formulations including improved thermal stability, zero VOCs, no HAPs, and no alkylphenols. Additionally, the present premixes can be used to formulate cleaners that show cleaning performance not typically seen with highly diluted systems, and they can be used to formulate cleaning formulations with close to neutral pH that can obtain cleaning values similar to alkaline formulations. The premixes of the invention can be used in the preparation of aqueous or semi-aqueous detergents formulations for household, institutional, and industrial applications with low or zero VOCs.

The cationic surfactant employed in the premix of the present invention is a quaternary ammonium compound or mixtures thereof selected from the group of compounds represented by Formula I.

R₁R₂R₃R₄N⁺X⁻ (I)

wherein

R₁ is a linear or branched, saturated or unsaturated C₆-C₂₂ alkyl group or aralkyl or R₅-[O(CH₂)_{y}]ₘ;

R₂ is C₁-C₆ alkyl group or R₁;

R₃ and R₄ are C₂-C₄ random or block or homogeneneous polyoxyalkylene groups;

R₅ is a linear or branched, saturated or unsaturated C₁-C₁₈ alkyl group, or hydrogen; m is interger from 1-20;

y is either 2 or 3 and

X⁻ is an anion, preferably chloride, methyl sulfate, bromide, iodide, acetate, carbonate, and the like.

Preferred compounds within the scope of general Formula I are represented by Formula II, below.

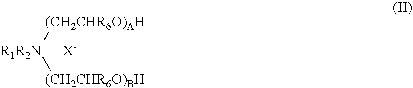

wherein R₁, R₂, and X⁻ are as defined above;

each R₆ is independently at each occurrence C₁-C₂ alkyl or H, and A and B are integers greater than or equal to 1 wherein A+B is 2-50.

Further preferred compounds within the scope of general Formula II are represented by General Formula III, below.

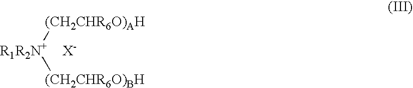

wherein R₁, R₂ and X⁻ are as defined above; each R₆ is independently at each occurrence C₁-C₂ alkyl or H, and A and B are integers greater than or equal to 5 wherein A+B equal 5-40.

The cationic surfactant component of the present invention is preferably a bis(ethoxylated) quaternary ammonium compounds including but not limited to: stearyl methyl bis(ethoxy) ammonium chloride (12 moles EO), stearyl ethyl bis(ethoxy) ammonium ethyl sulfate (15 moles EO), tallow methyl bis(ethoxy) ammonium methyl sulfate (15 moles EO), tallow ethyl bis(ethoxy) ammonium methyl sulfate (15 moles EO), hydrogenated tallow methyl bis(ethoxy) ammonium chloride (15 moles EO), coco methyl bis (ethoxy) ammonium chloride (20 moles EO), N-tallowalkyl-N,N′-dimethyl-N-N′-polyethyleneglycol-propylenebis-ammonium-bis methylsulphate, polyoxyethylene (3) tallow propylenedimonium dimethylsulphate, polyoxyethylene (2) coco-benzonium chloride, isodecylpropyl dihydroxyethyl methyl ammonium chloride, isotridecylpropyl dihydroxyethyl methyl ammonium chloride, methyl dihydroxyethyl isoarachidaloxypropyl ammonium chloride, polyoxypropylene (9) methyl diethyl ammonium chloride, polyoxypropylene (25) methyl diethyl ammonium chloride, polyoxypropylene (40) methyl diethyl ammonium chloride and the like. Mixtures of these compounds can also be used in the context of the present invention. Additionally, in the above descriptions, the amount of ethoxylation is the total ethoxylation for the molecule. One of ordinary skill in the art will recognize that these values can be varied while remaining within the spirit and scope of the present invention. Additionally, one of ordinary skill in the art will recognize that the values m and n can be varied, but their combined total has a profound affect on HLB.

The ammonium compounds of the present invention preferably have an HLB of from 22 to 35 on the Davies scale. More preferably the cationic is balanced on the hydrophilic side with the HLB being 25-35 on Davies scale. Particularly preferred cationic surfactant components include cocomethyl bis[ethoxylated] (15)-quaternary ammonium chloride, cocomethyl bis[ethoxylated] (17)-quaternary ammonium chloride and tallowmethyl bis[ethoxylated] (15)-quaternary ammonium chloride available from Akzo Nobel Chemicals, Inc. under the trademark Ethoquad® C/25, Berol® 555 and Ethoquad® T/25.

A further constituent of the invention is a nonionic surfactant wherein a portion of the molecule is based on polymeric alkylene oxides that have a nucleus group including without limitation, amides, phenols, thiols, alcohols and secondary alcohols. The nonionic surfactant of the present composition can be selected from the group consisting of alkanolamides, alkoxylated alcohols, alkoxylated amines, phenyl polyethoxylates, lecithin, hydroxylated lecithin, fatty acid esters, glycerol esters and their ethoxylates, alkylphenols, alkoxylated alkylphenols, glycol esters and their ethoxylates, esters of propylene glycol, sorbitan, ethoxylated sorbitan, polyglycosides, and the like, and mixtures thereof. Alkoxylated alcohols, preferably ethoxylated alcohols are the most preferred nonionic surfactants. A preferred class of nonionic surfactants is represented by Formula IV.

R—O—R₂ (IV)

wherein R is defined as a linear or branched alkyl group with 3-22 carbon atoms, preferably a linear alcohol type with 15 carbon atoms or less and/or mixtures thereof, and R₂ is polyoxyalkylene.

Preferred compounds within the scope of general Formula IV, are represented by Formula V below:

R—O—(CH₂CH₂O)ₙH (V)

wherein R is defined as a linear or branched alkyl group with 3-22 carbon atoms, preferably a linear alcohol type with 8-15 carbon atoms or less and/or mixtures thereof, and n=3-50, but preferably 2-8 moles of ethoxylation with either narrow or broad range distribution. The nonionic surfactant of the above description typically has a cloud point of less than 50° C. with an HLB range of 6-14 on Griffin scale. In another embodiment, it has a cloud point of less than 40° C. and an HLB of 8-12 on Griffin scale. Ethoxylated alcohols that have give Narrow Range (NR) or peaked ethoxylation distribution are particularly preferred. It is also preferred that such ethoxylated alcohols that have less than 1% free alcohol present. The nonionic surfactant component of the present invention can be prepared by various methods in the prior art. Alternatively, many nonionics useful in the context of the present invention are commercially available. Specific examples of nonionic surfactants employable in the context of the present invention include but are not limited to polyoxyethylene (3) 2-ethylhexanol, polyethyleneglycol-4 ethylhexyl ether, polyethyleneglycol-5 ethylhexanol, polyoxyethylene (4) 2-ethylheptyl, polyoxyethylene (5) isodecanol and polyoxyethylene (5) 2-propylhepanol, laury alcohol ethoxylated with 3 moles of ethylene oxide (EO), coco alcohol ethoxylated with 3 moles of EO, stearyl alcohol ethoxylated with 5 moles of EO, mixed C₁₂-CI₅ alcohol ethoxylated with 7 moles EO, mixed secondary C₁₁-C₁₅ alcohol ethoxylated with 7 moles EO, mixed C₉-C₁₁ linear alcohol ethoxylated with 6 moles EO, a C₆-C₁₀ alcohol ethoxylated with 3.5 moles EO, a C₈-C₁₀ alcohol ethoxylated with 4.5 moles EO, and the like. The preferred nonionic surfactant components include C₉₋₁₁ with 4 ethylene oxides (NR), C₉₋₁₁ with 5.5 ethylene oxides (NR), available from Akzo Nobel Chemical, Inc. under trademark Berol® 260 and Berol® 266.0ther preferred compounds include C₁₁ with 5 ethylene oxides and C₉₋₁₁ ethylene oxides available from Tomah under the Tradename Tomadol® 1-4 and Tomadol® 91-6. Other nonionic surfactants include C₈₋₁₀ 4 ethylene oxides NR available from Sasol under the Trademark Novell® 810-4.

The ratio of said at least one nonionic surfactant to said at least one cationic surfactant is generally in the range of from 1:5 to 5:1 depending on the cloud point of the nonionic. When employing nonionic surfactants with cloud point less than 40° C. in water, the ratio is generally in the range of 2.9:1 to 1:2.9 by weight.

A third component of this invention is a sufficient amount of a polyhydric alcohol having at least three free hydroxyl groups and not listed on the HAPs list in The Clean Air Act Section 112. Examples of suitable polyhydric alcohol compounds are glycerol, diglycerol, triglycerol, polyglycerols, pentaerythriol, inositol, trimethylol ethane, trimethylol propane, sorbitol, mannitol, and the like. The preferred compounds should be HAPs free, and have at least three hydroxyl groups. Generally, from about 1 to about 25% by weight polydric alcohol comprises an effective amount. In another embodiment, an effective amount of polyhydric alcohol is from about 5 to 23% by weight.

The cleaning and degreasing composition of the present invention may also include various optional components including, but not limited to, builders and auxilliaries typically employed in such cleaning preparations. Examples of suitable builders that may be used include, but are not limited to, TSPP, STPP, silicates, citrates, EDTA, silicates, carbonates and the like. Similarly, examples of suitable auxilliaries include, but are not limited to, sodium hydroxide, potassium hydroxide, TEA and MEA. The composition of the present invention also may contain various optional ingredients such as corrosion inhibitors, scale inhibitors, biocides, perfumes, polymers, dyes, and the like.

The advantages associated with the use of cleaning compositions according to the present invention are numerous with the most obvious being that they do not employ volatile solvents or any HAPs, due to their thermal stability. Secondly, the present composition will provide cleaning formulations with enhanced cleaning properties with respect to both polar and non-polar oils, thereby imparting superior grease cutting properties to the composition, at reduced pH values and upon dilution.

The invention will now be illustrated by the following nonlimiting examples.

### EXAMPLE 1

In order to determine ease of dilution, several premix compositions were tested comprising a quaternary ammonium compound combined with either a nonionic and/or a required amount of polyhydric alcohol as shown in Table 1. Two grams of the various premixed blends where added into the bottom of a vial, followed by the addition of 18 grams of water equilibrated to 15° C. The physical state of the premix blend was observed and the amount of the premix dissolved at various intervals was recorded. The various premix compositions where ranked on speed of dissolution (1 being the fastest and 6 the slowest).

TABLE 1
Dissolution of Premix Blends in Cold Water

| | Premix Blends | | | | | | | | | |
|---|---|---|---|---|---|---|---|---|---|---|
| Component | A | B | C | D | E | F | G | H | I | J |
| Quat | 100 | 80 | 60 | 50 | 60 | 50 | 40 | 40 | 40 | 40 |
| Nonionic | | | | 50 | 20 | 30 | 40 | 40 | 40 | 40 |
| Glycerol | | 20 | 40 | | 20 | 20 | 20 | | | 20 |
| Ethylene glycol | | | | | | | | 20 | | |
| Butoxyethanol | | | | | | | | | 20 | |
| D-sorbitol | | | | | | | | | | 20 |

Premix 2 g/20 water at 15° C.

| | | | | | | | | | | |
|---|---|---|---|---|---|---|---|---|---|---|
| Form | Gel | Gel | Gel | Gel | Gel | Gel | No gel | No gel | No gel | No gel |

Percentage dissolved after x minutes

| | | | | | | | | | | |
|---|---|---|---|---|---|---|---|---|---|---|
| 3 minutes | 0 | 20 | 20 | 15 | 5 | 90 | 100 | 100 | 100 | 100 |
| 6 minutes | 25 | 40 | 40 | 30 | 60 | 100 | | | | |
| 51 minutes | 40 | 80 | 80 | 60 | 100 | | | | | |
| 107 minutes | 50 | 90 | 100 | 90 | | | | | | |
| 127 minutes | 75 | 100 | | 100 | | | | | | |
| Ranking | 6 | 5 | 4 | 5 | 3 | 2 | 1 | 1 | 1 | 1 |

Quat = tallowmethyl bis[ethoxylated] (15)-quaternary ammonium chloride
Nonionic = C₉₋₁₁ with 4 ethylene oxides NR

Based on the above observations for ease of dissolution of the quaternary ammonium compound, it is deduced that both the nonionic and a polyhydric alcohol are required. As the amount of quaternary ammonium compound decreases and the amount of both nonionic and glycerol increases, the dissolution rate dramatically increases. Although ethylene glycol and butoxyethanol achieve a similar effect, they are not suitable because both compounds are considered HAPs. A similar effect on dissolution can be obtained by the use of alcohol, propylene glycol, a nonionic based on ethoxylated alcohol with free alcohol or similar components.

### EXAMPLE 2

Premix blends were either based on nonionic surfactant with free alcohol or propylene glycol. EPA test method 24 was employed to determine volatile matter and water content. ASTM D2369-81 and ASTM D4017-81 test methods were employed to determine the VOC content of various premix compositions shown in Table 2.

TABLE 2
VOCs and Thermal Stability of Various Blends.

| | Premix Blends | | | | | | | | |
|---|---|---|---|---|---|---|---|---|---|
| Component | A | B | C | D | E | F | G | H | I |
| Quat | 30 | 40 | 30 | 40 | 36 | 40 | 40 | 40 | 40 |
| Nonionic | 50 | 40 | 40 | 40 | 39 | 40 | 40 | 40 | 40 |
| Propylene glycol | 20 | 20 | 20 | | | | | | |
| Glycerol | | | | 20 | 15 | | | | |
| Ethylene glycol | | | | | | | 20 | | |
| Butoxyethanol | | | | | | | | 20 | |
| D-sorbitol | | | | | | | | | 10 |
| Water | | | | | | 20 | | | 10 |

Determination of volatile organic compounds by EPA Method 24

| | | | | | | | | | |
|---|---|---|---|---|---|---|---|---|---|
| Water | 0.3 | 0.8 | 0.8 | 0.5 | 0.5 | 20.6 | 0.8 | 0.8 | 10 |
| Solids (110° C./(hour) | 92.3 | 89.8 | 92.3 | 99.3 | 99.6 | 79.7 | 90.6 | 84.5 | 90.2 |
| VOCs | 7.4 | 9.4 | 6.9 | 0 | 0 | 0 | 8.6 | 14.7 | 0 |
| Solids (120° C.) | 77.7 | 75.8 | 74.2 | 99.14 | 98.4 | 79 | 76.1 | 77.3 | 89.4 |

Solids error ± 0.6% and water error ± 0.4%
Quat = cocomethyl bis[ethoxylated] (15)-quaternary ammonium chloride
Nonionic = C₉₋₁₁ with 4 ethylene oxides NR

The results show that blends based on propylene glycol and ethylene glycol have ˜7-9% VOCs according to EPA test method 24, while blends based on glycerol and sorbitol do not have any VOCs. Review of the various ingredients revealed that the quaternary ammonium compound, nonionic surfactant and glycerin had minimal loss at 110° C. for 1 hour, while propylene glycol had a 30% weight loss. Weight loss observed at 110° C. is slightly higher than would be expected if 30% of the propylene glycol was lost from these blends. Additionally, when solids analysis was done at 120° C., the total weight loss was greater than total amount of propylene glycol added to blends A-C, even though propylene glycol alone at this temperature does completely degrade. Studies on the raw material found that the nonionic was also sensitive to elevated temperatures. However, blends D-F and I with the nonionic surfactant plus either the quaternary ammonium compound and/or higher polyhydric alcohol were more thermally stable. Combination of glycerol with the nonionic surfactant was tried, but the two components were immiscible and a quaternary ammonium compound was required to impart stability to the premix composition.

Blends A and E where submitted for Thermal Gravity Analysis (TGA) and Differential Scanning Colorimetry (DSC). FIGS. 1 and 2 show the thermal events seen. With blend A, a rapid weight loss of 24% is seen between room temperature and 130° C. followed by a single step weight loss extrapolated to 153° C. in the TGA. The DSC (FIG. 2) shows two endotherms between 73° C. and 213° C. that correspond to the weight loss in the TGA. FIGS. 3 and 4 show the thermal events seen with blend E where a weight loss of 1.6% occurs between room temperature and 70° C. followed by a single step weight loss extrapolated to 113° C. The DSC (FIG. 4) shows a broad multi-peaked endotherm between 114° C. and 209° C. that corresponds to the weight loss seen in the TGA. These results suggest that blend A weight loss occurs in two phases one at ˜70° C. and the second at 150° C. The first phase looses one quarter of its mass before 150° C. and the second loss occurs between 150-225° C. for the remaining material. Blend E, however, shows only a single step more gradual loss ocurring between 113° C. and 250° C., resulting in a blend that is more thermally stable. Blend A shows an initial loss that is greater than only propylene glycol loss suggesting that the propylene glycol is promoting the decomposition of another component most likely the nonionic surfactant in the blend. It is postulated that the presence of the glycerol and quaternary ammonium compound in blend E stabilizes the thermal decomposition of the nonionic. Comparison of the two blends shows that blend A loses 12%, while blend E loses 2% between 50-100° C. giving blend E less VOCs under EPA method 24 conditions.

### EXAMPLE 3

For cleaning evaluations two premix blends based on the above innovation were prepared. These premix compositions were prepared by mixing the nonionic surfactant with quaternary ammonium compound followed by glycerol addition. Water and other minor ingredients can optionally be added to meet viscosity, pH, or other required specifications. For comparative purposes, blends with propylene glycol were prepared.

TABLE 3
Premix Blends For Cleaning Formulations

| Component | Blend A | Blend B | Blend C | Blend D | Blend E |
|---|---|---|---|---|---|
| Premix | | | | | |
| Quat | 33 | 36 | 30 | 36 | |
| Nonionic | 47 | 49 | 50 | 49 | 49 |
| Glycerol | 20 | 15 | — | | 15 |
| Proplyene Glycol | — | — | 20 | | |
| Sorbitol | | | | 15 | |
| Anionic | | | | | 36 |

Quat = cocomethyl bis[ethoxylated] (15)-quaternary ammonium chloride
Nonionic = C₉₋₁₁ with 4 ethylene oxides NR
Anionic = sodium n-decyl diphenyloxide disulphate

The formulations were prepared by adding sodium metasilicate to the water and allowing it to completely dissolve before adding tetrapotassium pyrophosphate (TKPP). Once these components were dissolved, a 40% solution of the tetra sodium salt of ethylenediamine tetraacetic acid (EDTA) was added. Once all the electrolytes completely dissolved, the various premix blends were added to the formulation. The other formulations shown in Table 3 were prepared in the same manner with the electrolytes dissolved first before addition of the premix blend. Formulations 1 through 7 were diluted in water and tested using a non-mechanical cleaning test as follows.

Painted panels are washed with detergent, cleaned with IPA, and allowed to dry before use. A spectrophotometer was placed on the marked sections and a base reading was taken (recorded as ΔL_{B}, Δa_{B} or Δb_{B}—the base reading). A greasy soil (obtained from train engines) was then applied to the test panel with a brush and the soil was smoothed over the surface to obtain an even coating using a Kimwipe. The plates were then allowed to stand for 12 hour before testing. The spectrophotometer was then placed on the marked sections of the soiled panels and the soiled reading was taken (recorded as ΔL_{S}, Δaₛ or Δb_{S}—the soiled reading). 100 mls of each of the test formulations were prepared and the formulations were diluted with tap water. Twenty ml of each diluted test cleaner was poured onto the soiled plate (three solutions per plate). On each test plate twenty mls of the control solution at 1:10 dilution was tested and used as a reference for product/plate performance. The test formulations were left on the plates for twenty seconds, and then the plates were rinsed using a low-pressure water spray. The plates were then cleaned from the bottom up to remove the emulsified dirt and then allowed to air dry. The spectrophotometer was then placed on the marked sections and a final reading was taken (marked as ΔL_{C}, Δa_{C} or Δb_{C}—the cleaned reading). The Delta values were used to calculated the amount of soil removed from the panel using the C.I.E. Lab or L*a*b Color Space standard.

ΔE₁=\sqrt{(ΔL_{S}−ΔL_{B})²}+(Δa_{S}−Δa_{B})²+(Δb_{S}−Δb_{B})²

ΔE₂=\sqrt{(ΔL_{C}−ΔL_{B})²}+(Δa_{C}−Δa_{B})²+(Δb_{C}−Δb_{B})²

ΔE₁ is the color difference between the base reading and soiled reading. ΔE₂ is the color difference between the base reading and the cleaned reading Percentage of soil removal is calculated as shown below:

Soil Removal(%)=(ΔE₁−ΔE₂/ΔE₁)×100

Each formulation test was repeated three times and the standard deviation calculated. If the standard deviation of a single test was greater than 15%, the formulation was re-tested and any outlying points eliminated. In cases that the repeated studies show no outlying points, both data sets are combined. The control solution should give 95±7% soil removal.

TABLE 4
Various Industrial and household cleaning formulations plus their performance

| Formulation | 1 | 2 | 3 | 4 | 5 | 6 | 7 | 8 | 9 |
|---|---|---|---|---|---|---|---|---|---|
| Premix Blend | A | B | C | D | E | B | C | B | C |
| | 9 | 9 | 9 | 9 | 9 | 9 | 9 | 9 | 9 |
| Na-EDTA (40%) | 9 | 9 | 9 | 9 | 9 | | | 4.5 | 4.5 |
| TKPP | 4 | 4 | 4 | 4 | 4 | | | | |
| Trisodium citrate | | | | | | 6 | 6 | 6 | 6 |
| Water | 78 | 78 | 78 | 78 | 78 | 85 | 85 | 80.5 | 80.5 |
| Ph (10% in water) | 12 | 12 | 12 | 12 | 12 | 8 | 8 | 11 | 11 |

Soil Removed (%)

| | | | | | | | | | |
|---|---|---|---|---|---|---|---|---|---|
| Dilution | | | | | | | | | |
| 1:40 | 87 ± 3 | 87 ± 2 | 85 ± 4 | 71 ± 3 | 24 ± 4 | 80 ± 4 | 57 ± 8 | 82 ± 5 | 83 ± 5 |
| 1:60 | 76 ± 6 | 75 ± 4 | 58 ± 4 | 77 ± 9 | 19 ± 4 | | | 76 ± 4 | 49 ± 6 |
| 1:80 | 30 ± 5 | 48 ± 6 | 11 ± 3 | | | | | | |

Typical industrial formulations were used in formulations 1 through 5, and they all demonstrated similar cleaning ability at the lowest dilution (1:40) regardless of the make up of the premix blend, with the exception of blend 5, a comparative blend that utilizes an anionic hydrotrope in place of the quaternary ammonium compound. However, as the formulations are further diluted formulations 1, 2 and 4 show significantly greater cleaning, suggesting that the glycerol contributes to the cleaning. This retention of performance upon dilution is also seen with blend D which contains sorbitol. Formulations 6 through 9 are concentrates that can be used in industrial formulations, but they are more typically employed in consumer formulations.

One skilled in the art would expect a drop in cleaning performance with formulations having a pH value of less then 10, as compared with high pH formulations. Higher pH contributes to cleaning in several ways, including, but not limited to, particulate dispersions, protein denaturing and saponification of fats and oils. Formulations with lower pH show a drop in cleaning performance when the formulation employs propylene glycol, but surprisingly superior cleaning, even at the lowest dilution (1:40), is seen in formulation 6 which utilizes glycerol. The cleaning formulations with the higher pH again show no performance difference at the lowest dilution (1:40) in formulations 6 and 7. However, when the formulations are diluted further the premix composition containing glycerol has significantly greater cleaning than the premix using propylene glycol. A slight increase in surfactant content of these formulations cannot alone explain the dramatic differences seen in the cleaning performance of these formulations.

### EXAMPLE 4

Using design of experiments, the preferred levels of the cationic surfactant, nonionic surfactant and glycerol in the premix composition were determined. The following example determines the required amount of quaternary ammonium compound necessary to make a stable formulation, the optimal level of glycerol for cleaning, and the minimal amount of nonionic surfactant required. Metasilicate and TKPP were dissolved in water before the premix compositions were added to electrolyte solution. The solution was diluted 1:60 in tap water and cleaning ability was determined as describe in example 3. The formulation concentrates were observed and the number of phases was noted as shown in Table 5. The formulation concentrates were also heated until the cloud point was observed.

TABLE 5
Formulations and cleaning results using adjusted levels
of the various components

| | | | | | | | | | Soil removal (%) |
|---|---|---|---|---|---|---|---|---|---|
| Formula | Quat | nonionic | glycerol | Na | TKPP | water | Cloud pt | Phase | 1:60 |
| 1 | 5 | | | 2 | 3 | 90 | 66 | 1 | 49 ± 3 |
| 2 | 1.8 | 2.45 | 0.75 | 2 | 3 | 90 | <95 | 1 | 61 ± 3 |
| 3 | 1 | 3 | 1 | 2 | 3 | 90 | 25 | 2 | 45 ± 2 |
| 4 | 1 | 2.25 | 1 | 2 | 3 | 90.75 | 62 | 1 | 44 ± 2 |
| 5 | 1.13 | 2.63 | 1.13 | 2 | 3 | 90.11 | 62 | 1 | 61 ± 5 |
| 6 | 1 | 3 | 0.25 | 2 | 3 | 90.75 | 25 | 2 | 61 ± 3 |
| 7 | 1.38 | 2.25 | 0.6 | 2 | 3 | 90.77 | <95 | 1 | 58 ± 1 |
| 8 | 1.31 | 2.69 | 0.5 | 2 | 3 | 90.5 | 76 | 1 | 62 ± 0.3 |
| 9 | 1.75 | 2.25 | 0.25 | 2 | 3 | 90.75 | <95 | 1 | 58 ± 0.7 |
| 10 | 1 | 2.25 | 1.5 | 2 | 3 | 90.25 | 62 | 1 | 32 ± 4 |
| 11 | 1.25 | 3.5 | 0.25 | 2 | 3 | 90 | 45 | 1 | 67 ± 2 |
| 12 | 1.13 | 3.13 | 0.5 | 2 | 3 | 90.24 | <95 | 1 | 67 ± 5 |

Quat = cocomethyl bis[ethoxylated] (15)-quaternary ammonium chloride
Nonionic = C₉₋₁₁ with 4 ethylene oxides (NR)

Results indicate that when the ratio of cationic to nonionic is greater than 1:2.9 there is an insufficient amount of hydrotroping ability in the premix composition to form a stable formulation with typical builders and chelating agent without the addition of a secondary hydrotrope. This can be seen in formulations 3 and 6, both of which phase separate. The ratio of cationic surfactant to nonionic surfactant in these formulations was 1:3, while formulations 11 and 12 are one phase and stable with a ratio of 1:2.8.

Glycerol present in these formulations provides a small coupling contribution when comparing formulations 11 and 12 as the cloud point is dramatically increased. However coupling capacity is not enough to stabilize formulation 3 when the ratio of cationic to nonionic exceeds 1:2.9.

The results indicate that there is optimal level of glycerol that provides an unexpected boost in cleaning compared to the control formulation 1. Formulation 1 is based on a competitive material that is a blend of nonionic and cationic surfactants, but is not VOC free. Formulations with ˜5-23% glycerol all show a significant boost in cleaning over formulation 1. However, going from 23% glycerol in formulation 5 to 24% in formulation 4 shows a dramatic drop of in cleaning. A further increase in glycerol to 32% in formula 10 shows a 10% drop in cleaning. The one formulation that does not follow this trend is formulation 3, but cleaning results from such unstable formulations are commonly known to be unpredictable.

### EXAMPLE 5

9% of the premix blends B and C from example 3 were separately combined with 4% TKPP, 2% sodium metasilicate and 9% of a 40% solution of EDTA as describe in example 3. These formulations were diluted 1:10 with tap water and evaluated for cleaning ability on kitchen soils.

White ceramic tiles are washed with detergent, cleaned with IPA and allowed to dry before use. A spectrophotometer was placed on the pre-marked sections and a base reading was taken (recorded as ΔL_{B}, Δa_{B} or Δb_{B}—the base reading). A kitchen soil composition containing oils, lard, proteins, carbohydrates and carbon black, was then applied to the test tile with a brush (approximately 0.25 grams.) The plates were baked at 200° C. for 45 minutes and then allowed to stand at room temperature for 12 hours before testing. The spectrophotometer was then placed on the marked sections of the soiled panels and the soiled reading was taken (recorded as ΔL_{S}, Δa_{S} or Δb_{S}—the soiled reading). 100 mls of each of the test formulations were prepared and diluted with tap water as indicated in Table 6. Using a pressurized spray can, each test solution was sprayed on the solied tile for 1 minute at a distance of one foot. The test formulations were left for thirty seconds after which the tiles were placed into a Gardener washability apparatus. Next the tiles were cleaned using a water damp sponge with five strokes of the sponge. The tiles were then rinsed under a low-pressure water spray and allowed to air dry. After drying, the spectrophotometer was placed on the marked sections and the final reading was taken (recorded as ΔL_{C}, Δa_{C} or Δb_{C}—the cleaned reading). The Delta values were used to calculated the amount of soil removed from the panel using the C.I.E. Lab or L*a*b Color Space standard method employed in example 3.

Each formulation test was repeated three times and the standard deviation calculated. If the standard deviation of a single test was greater than 15%, the formulation was re-tested and any outlying points eliminated. The results of the various test formulations are shown below.

TABLE 6
Cleaning of kitchen Soils

| Formulation | Soil removal (%) |
|---|---|
| 1:10 Formulation using Premix blend B | 82 ± 2 |
| 1:10 Formulation using Premix blend C | 71 ± 5 |
| Commercial product with solvent (Lysol) | 81 ± 0.4 |

The above results clearly show the superior cleaning properties of the premix blend of the present invention containing glycerol compared to the control sample which utilizes propylene glycol. The cleaning performance of the premix of the present invention was similar to that of a commercial ready to use (RTU) cleaner, which is solvent based and has VOCs.

We claim:

1. A cleaning and degreasing composition which comprises at least one nonionic surfactant and at least one cationic surfactant, an effective amount of at least one polyhydric alcohol, and optionally, water.

2. The composition of claim 1 wherein said at least one nonionic surfactant is selected from the group consisting of alkanolamides, alkoxylated alcohols, alkoxylated amines, phenyl polyethoxylates, lecithin, hydroxylated lecithin, fatty acid esters, glycerol esters and their ethoxylates, alkylphenols, ethoxylated alkylphenols, glycol esters and their ethoxylates, esters of propylene glycol, sorbitan, ethoxylated sorbitan polyglycosides and mixtures thereof.

3. The composition of claim 2 wherein said at least one nonionic surfactant is an ethoxylated linear or branched alcohol of the formula:
R—O—R₂ (IV)
wherein R is defined as a linear or branched alkyl group with 3-22 carbon atoms, and R₂ is polyoxyalkylene.

4. The composition of claim 3 wherein said at least one nonionic surfactant is a compound according to Formula V below:
R—O—(CH₂CH₂O)ₙH (V)
wherein R is defined as a linear or branched alkyl group with 3-22 carbon atoms, and n=3-50.

5. The composition of claim 4 wherein R is a linear or branched alkyl group of from 8-15 carbon atoms and said nonionic contains 2-8 moles of ethoxylation with either narrow or broad range distribution.

6. The composition of claim 3 wherein said nonionic has a cloud point of less than 50° C. with an HLB range of 6-14 on Griffin scale.

7. The composition of claim 6 wherein said nonionic has a cloud point of less than 40° C. and an HLB of 8-12 on Griffin scale.

8. The composition of claim 1 wherein said at least one nonionic surfactant is selected from the group consisting essentially of polyoxyethylene (3) 2-ethylhexanol, polyethyleneglycol-4 ethylhexyl ether, polyethyleneglycol-5 ethylhexanol, polyoxyethylene (4) 2-ethylheptyl, polyoxyethylene (5) isodecanol and polyoxyethylene (5) 2-propylhepanol, laury alcohol ethoxylated with 3 moles of ethylene oxide (EO), coco alcohol ethoxylated with 3 moles of EO, stearyl alcohol ethoxylated with 5 moles of EO, mixed C₁₂-C₁₅ alcohol ethoxylated with 7 moles EO, mixed secondary C₁₁-C₁₅ alcohol ethoxylated with 7 moles EO, mixed C₉-C₁₁ linear alcohol ethoxylated with 6 moles EO, a C₆-C₁₀ alcohol ethoxylated with 3.5 moles EO, a C₈-C₁₀ alcohol ethoxylated with 4.5 moles EO, and mixtures thereof.

9. The composition of claim 1 wherein the ratio of said at least one nonionic surfactant to said at least one cationic surfactant is in the range of from 1:5 to 5:1 by weight.

10. The composition of claim 1 wherein the ratio of said at least one nonionic surfactant to said at least one cationic surfactant is in the range of 2.9:1 to 1:2.9 by weight.

11. The composition of claim 1 wherein said at least one cationic surfactant is represented by Formula I
R₁R₂R₃R₄N⁺X⁻ (I)
wherein
R₁ is a linear or branched, saturated or unsaturated C₆-C₂₂ alkyl group or aralkyl or R₅-[O(CH₂)_{y}]ₘ;
R₂ is C₁-C₆ alkyl group or R₁;
R₃ and R4 are C₂-C₄ random or block or homogeneneous polyoxyalkylene groups;
R₅ is a linear or branched, saturated or unsaturated C₁-C₁₈ alkyl group, or hydrogen; m is intenger from 1-20;
y is 2 or 3 and
X⁻ is an anion.

12. The composition of claim 1 wherein said anion is selected from the group consisting essentially of preferably chloride, methyl sulfate, bromide, iodide, acetate, carbonate, and mixtures thereof.

13. The composition of claim 11 wherein said at least one cationic surfactant is represented by Formula II, 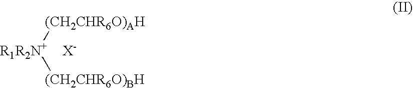
wherein R₁, R₂, and X are as defined above;
each R₆ is independently at each occurrence C₁-C₂ alkyl or H, and A and B are integers greater than or equal to 1 wherein A+B is 2-50.

14. The composition of claim 13 wherein said at least one cationic surfactant is represented by Formula III, 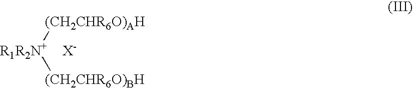
wherein R₁, R₂ and X⁻ are as defined above; each R6 is independently at each occurrence C₁-C₂ alkyl or H, and A and B are integers greater than or equal to 5 wherein A+B equal 5-40.

15. The composition of claim 1 wherein the cationic surfactant is selected from the group consisting essentially of bis(ethoxylated) quaternary ammonium compounds including but are not limited to: stearyl methyl bis(ethoxy) ammonium chloride (12 moles EO), stearyl ethyl bis(ethoxy) ammonium ethyl sulfate (15 moles EO), tallow methyl bis(ethoxy) ammonium methyl sulfate (15 moles EO), tallow ethyl bis(ethoxy) ammonium methyl sulfate (15 moles EO), hydrogenated tallow methyl bis(ethoxy) ammonium chloride (15 moles EO), coco methyl bis (ethoxy) ammonium chloride (20 moles EO), N-tallowalkyl-N,N′-dimethyl-N-N′-polyethyleneglycol-propylenebis-ammonium-bis methylsulphate, polyoxyethylene (3) tallow propylenedimonium dimethylsulphate, polyoxyethylene (2) coco-benzonium chloride, isodecylpropyl dihydroxyethyl methyl ammonium chloride, isotridecylpropyl dihydroxyethyl methyl ammonium chloride, methyl dihydroxyethyl isoarachidaloxypropyl ammonium chloride, polyoxypropylene (9) methyl diethyl ammonium chloride, polyoxypropylene (25) methyl diethyl ammonium chloride, polyoxypropylene (40) methyl diethyl ammonium chloride and mixtures thereof.

16. The composition of claim 1 wherein said at least one polyhydric alcohol contains at least three hydroxyl groups.

17. The composition of claim 16 wherein said polyhydric alcohol is selected from the group consisting of glycerol, diglycerol, triglycerol, polyglycerols, pentaerythriol, inositol, trimethylol ethane, trimethylol propane, sorbitol, mannitol, and mixtures thereof.

18. The composition of claim 1 which comprises from 1 to about 25% by weight of polyhydric alcohol.

19. The composition of claim 18 which comprises from 5 to 23% by weight of polyhydric alcohol.

20. The composition of claim 1 which comprises:
at least one cationic surfactant is selected from the group consisting essentially of bis(ethoxylated) quaternary ammonium compounds including but are not limited to:
stearyl methyl bis(ethoxy) ammonium chloride (12 moles EO), stearyl ethyl bis(ethoxy) ammonium ethyl sulfate (15 moles EO), tallow methyl bis(ethoxy) ammonium methyl sulfate (15 moles EO), tallow ethyl bis(ethoxy) ammonium methyl sulfate (15 moles EO), hydrogenated tallow methyl bis(ethoxy) ammonium chloride (15 moles EO), coco methyl bis (ethoxy) ammonium chloride (20 moles EO), N-tallowalkyl-N,N′-dimethyl-N-N′-polyethyleneglycol-propylenebis-ammonium-bis methylsulphate, polyoxyethylene (3) tallow propylenedimonium dimethylsulphate, polyoxyethylene (2) coco-benzonium chloride, isodecylpropyl dihydroxyethyl methyl ammonium chloride, isotridecylpropyl dihydroxyethyl methyl ammonium chloride, methyl dihydroxyethyl isoarachidaloxypropyl ammonium chloride, polyoxypropylene (9) methyl diethyl ammonium chloride, polyoxypropylene (25) methyl diethyl ammonium chloride, polyoxypropylene (40) methyl diethyl ammonium chloride and mixtures thereof;
at least one nonionic surfactant is selected from the group consisting essentially of polyoxyethylene (3) 2-ethylhexanol, polyethyleneglycol-4 ethylhexyl ether, polyethyleneglycol-5 ethylhexanol, polyoxyethylene (4) 2-ethylheptyl, polyoxyethylene (5) isodecanol and polyoxyethylene (5) 2-propylhepanol, laury alcohol ethoxylated with 3 moles of ethylene oxide (EO), coco alcohol ethoxylated with 3 moles of EO, stearyl alcohol ethoxylated with 5 moles of EO, mixed C₁₂-C₁₅ alcohol ethoxylated with 7 moles EO, mixed secondary C ₁-C₁₅ alcohol ethoxylated with 7 moles EO, mixed C₉-C₁₁ linear alcohol ethoxylated with 6 moles EO, a C₆-C₁₀ alcohol ethoxylated with 3.5 moles EO, a C₈-C₁₀ alcohol ethoxylated with 4.5 moles EO, and mixtures thereof; and
an effective amount of at least one polyhydric alcohol selected from the group consisting of glycerol, diglycerol, triglycerol, polyglycerols, pentaerythriol, inositol, trimethylol ethane, trimethylol propane, sorbitol, mannitol, and mixtures thereof.

21. The composition of claim 20 which comprises from 5 to 23% by weight of polyhydric alcohol.

22. The composition of claim 20 wherein the ratio of said at least one nonionic surfactant to said at least one cationic surfactant is in the range of 2.9:1 to 1:2.9 by weight.
